(19) United States
(12) Patent Application Publication
(10) Pub. No.: US 2002/0158016 A1
(43) Pub. Date: Oct. 31, 2002

(54) Separation unit, a method for separation, and a device for mounting a separation unit in a separation apparatus

(76) Inventors: Jan Norberg, Dragor (DK); Eddie Thordarson, Bjarred (SE); Patrik Soderlund, Lund (SE); Fredik Hakansson, Malmo (SE); Shadi Yazarlo, Lund (SE); Lars-Ake Larsson, Lund (SE); Johan Berhin, Malmo (SE)

Correspondence Address: HARNESS, DICKEY & PIERCE, P.L.C., P.O. BOX 8910, RESTON, VA, 20195, US

(21) Appl. No.: 10/132,737

(22) Filed: Apr. 26, 2002

Related U.S. Application Data
(60) Provisional application No. 60/286,377, filed on Apr. 26, 2001.
(60) Provisional application No. 60/324,272, filed on Sep. 25, 2001.

(51) Int. Cl. B01L 11/00

(52) U.S. Cl. 210/634; 210/644; 210/645; 210/511; 210/541; 422/58; 422/69; 422/101; 436/178

(57) ABSTRACT

A modular separation system wherein a separation unit is separate from a mounting device that accommodates the separation unit in a separation apparatus. The mounting device is an integral part of the separation apparatus. A method for fluid-fluid extraction of an analyte from a sample fluid to a receiving fluid in a separation apparatus.

The present application hereby claims priority under 35 U.S.C. §119 on U.S. application Ser. No. 60/286377 filed Apr. 26, 2001 and U.S. application Ser. No. 60/324272 filed Sep. 25, 2001, the entire contents of which are hereby incorporated by reference.

### TECHNICAL FIELD

The present invention relates to a modular separation system where a separation unit is separate from a mounting device that accommodates the separation unit in a separation apparatus. The separation unit is used in fluid-fluid extraction of an analyte from a sample fluid into a receiving fluid. The mounting device is an integral and permanent part of a separation apparatus and carries the necessary fluid fittings. The invention also relates to a separation system comprising the separation unit insertable into and removable from a mounting device. The invention also relates to a method for fluid-fluid extraction of an analyte from a sample fluid into a receiving fluid in a separation apparatus according to the invention.

### BACKGROUND OF THE INVENTION

Separation (extraction) units according to the prior art, e.g. as described in the reference Jönsson, J. Å. et al: “Automated system for the trace analysis of organic compounds with supported liquid membranes for sample enrichment”, Journal of Chromatography A, 665 (1994), pages 259-268, comprises two solid blocks usually made of polymeric materials which are identical in the way they are machined, i.e. they contain machined holes for fluid connectors, drilled holes from the end of these holes to the fluid cavity which is machined in the centre of each block. One block also contains pre-drilled holes into which screws will fit and the other block contains means to receive the screws, essentially pre-machined female connections in the block itself or as steel inserts. A polymer sheet, often referred to as the membrane, is clamped between the blocks and the screws are tightened. The described extraction system is after this ready for use. However, a system assembled in this manner will need to be re-used because it involves so much manual work for exchanging the clamped polymer. A further disadvantage with these systems is that they are susceptible to carry-over problems associated with re-use. Another disadvantage is that the production of the systems is likely not to be able to deliver the best reproducibility as the blocks need to be machined and, furthermore, the operation is expensive. Since the assembly of the system is manual there is a risk that the pressure might not be uniform across the cavities and that the pressure will not be consistent from time-to-time when the system has been disassembled and reassembled again. Furthermore, the production does not guarantee that the blocks exhibit a good match when mounted and not tilted in relation to one another. Thus, if they are tilted the accessible membrane will differ and the extraction efficiency will decrease.

### DESCRIPTION OF THE INVENTION

An object of the present invention is to provide a modular system with a separate separation unit and a mounting device that accommodates the separation unit in a separation system. A further object of the invention is to provide a mounting device, which is an integral and permanent part of a separation apparatus and carries the necessary fluid fittings. Another object of the invention is to provide a separation system which comprises a mounting device with a separation unit insertable therein and removable therefrom. It is a further object of the invention to provide a separation system which allows for automation of fluid-fluid extraction and which, furthermore, allows for connection to any final analysis device, e.g. a chromatograph, a spectroscopic device, a flow injection system etc. It is a still further object of the invention to provide a separation apparatus, which may be directly coupled to an analysis apparatus, e.g. a chromatograph, a spectroscopic device, a flow injection system etc. It is a still further object of the invention to provide a separation unit, which is easy and cheap to manufacture. It is a further object of the invention to provide a separation unit, which can be easily fitted into a larger mounting device for positioning the separation unit in a separation apparatus. Further, it is an object of the invention to provide such a mounting device for positioning the separation unit. It is also an object of the invention to provide a method for fluid-fluid extraction which reduces the amount of sample fluid and/or receiving fluid required, and which allows for the direct connection of the device to any final analysis device, e.g. a chromatograph. It is a further object of the invention to provide a separation unit, a method for fluid-fluid extraction and a device for mounting the separation unit in a separation apparatus which is less labour-extensive, i.e. in which the number of steps to be carried out by an operator before and during extraction and in the test procedure are reduced.

A further object is to provide a separation apparatus comprising a separation unit, a mounting device in which a separation unit is insertable into and removable from.

A further object is to provide a separation apparatus comprising means for exchanging separation units.

Another object according to the invention is to provide a modular system with a separation unit with multiple cavities. A further object is to provide a separation apparatus comprising means for moving the multiple cavity separation unit and/or rotating it.

The modular system according to the present invention with a separation unit inserted into the permanent mounting device gives the following advantages:

No disassembly of the separation unit

A one-time assembly of fittings to the mounting device

Possible single-use of the fluid cavities, eliminates carry-over problems in these parts, and improves analytical precision

No operator handling of the separation medium reduces risk for contamination and reduces time consumption

The pressurisation of the separation unit will be uniform from unit-to-unit

Full automation possible, even when the cavities of the separation unit are used only once.

The process for producing the separation unit offers among the following advantages:

High unit-to-unit precision in dimensions

Low manufacturing prize

According to a first aspect, the present invention relates to a separation unit as defined in claim 1.

The separation unit may contain a separation medium, which can be of any nature, such as chromatographic materials and/or a membrane, preferably a membrane. The separation medium is arranged so that one or more analytes in the sample fluid can pass from the sample fluid via the separation medium to the receiving fluid. The sample fluid and the receiving fluid respectively can contact the separation medium simultaneously or sequentially.

When the present description mentions that the sample fluid cavity is connected to the receiving fluid cavity and the separation medium is a membrane support adapted or arranged so as to partly separate the sample fluid cavity from the receiving fluid cavity, it is meant that the sample fluid cavity, the receiving fluid cavity and the membrane support are arranged in relation to each other in a way that allows one or more analytes in the sample fluid to pass from the sample fluid through the membrane support to the receiving fluid.

Where in the present context the expression “an analyte” is used, this should be understood as meaning “one or more species of analytes”. Usually, a plurality of analytes is to be extracted in the separation unit according to the present invention.

The term “membrane support” should be understood as any material, including synthetic and organic materials, which is capable of at least partly separating two immiscible or partly miscible fluids or of facilitating the contact between two miscible fluids. The membrane support preferably has pores or perforations, which are adapted to accommodate a fluid. Thus, in case of a hydrophilic membrane support, an aqueous fluid may be accommodated in the pores or perforations, and in case of a hydrophobic membrane support, an organic fluid may be accommodated in the pores or perforations. The membrane support having its pores or perforations filled or partly filled with a fluid constitutes a membrane. In the present context, a “membrane” should be understood as any device or assembly capable of at least partly separating two immiscible or partly miscible fluids while allowing certain molecules to pass through the membrane from one fluid to another.

Alternatively, the membrane support may comprise a non-porous material, such as a non-porous polymeric material, such as silicon rubber. In the case of the membrane support comprising or being constituted by a non-porous material, the membrane support may constitute the membrane. If the non-porous material separates an aqueous fluid from an organic fluid, the non-porous material is normally wetted by the organic fluid, in which case the wetted non-porous material constitutes the membrane. If the non-porous material separates two aqueous fluids, the non-porous material is normally not wetted by fluid, in which case the non-porous material itself constitutes the membrane.

In the present context, the term “fluid-fluid extraction” should be interpreted broadly, as comprising any type of extraction between two fluids, such as liquids, or any kind of molecular diffusion between fluids, such as dialysis. According to the present definition, fluid-fluid extraction also comprises MMLLE (Microporous Membrane Liquid-Liquid Extraction). In the MMLLE technique as it has been demonstrated with gas chromatography, an organic liquid is continuously moving during the extraction step. MMLLE normally involves two valves of the kind normally used for liquid chromatography and an intermediate transfer of an extract, e.g. organic receiving fluid containing analytes, to a loop, thereby causing a more dispersed (diluted) sample. The transfer of the extract in this technique is normally performed by a gas pressure being exerted by the support gas flow in the gas chromatograph.

The sample fluid cavity preferably defines a volume of at most 50 μl, such as at most 40 μl, such as at most 20 μl, such as most 10 μl, such as at most 5 μl, such as at most 2 μl, such as at most 1 μl, such as most 0.5 μl. The sample fluid cavity may be of substantially the same size as the receiving fluid cavity. The volume of the receiving fluid cavity is at most 50 μl, such as at most 40 μl, such as at most 20 μl, such as at most 10 μl, such as at most 5 μl, such as at most 2 μl, such as at most 1 μl, such as most 0.5 μl.

Due to the small volumes of receiving fluid and sample fluid, which may be accommodated in the separation unit, hazardous effects to an operating person and to the environment are reduced. Moreover, due to the small volumes, the separation unit enables extraction from low volumes of sample, yet preserving possibilities of high volume ratios between sample and receiving fluid, important to e.g. liquid-liquid extraction. It further enables direct connection between extraction and an analysis apparatus, such as a chromatograph. Further, the separation unit according to the invention necessitates only very few steps to be carried out by an operator, whereby automation of the extraction procedure and possibly of the subsequent analysis procedure is facilitated.

While the volume of the sample fluid cavity suitably is less than 50 μl, the amount of sample fluid used for extraction is usually higher, as, during extraction, a flow of sample fluid is preferably continuously led through the sample fluid cavity. Thus, the amount of sample fluid flowing through the separation unit may preferably be between 0.3 and 5 ml. The receiving fluid may be stagnant, i.e. not flowing, during extraction, in which case the volume of receiving fluid used for extraction is approximately equal to the volume of the receiving fluid cavity.

The sample fluid may be an aqueous liquid or an organic liquid or a gas. Examples of aqueous liquids are any physiological liquid, e.g. chosen from the group consisting of whole blood, urine, sweat, plasma, serum, nasal secrete, cerebrospinal fluid and other liquids from living organisms. It can also be a non-physiological liquid, e.g. a liquid chosen from the group consisting of river water, sea water, lake water, effluent water, influent water, drinking water, ground water or a fine dispersion of solid matter in aqueous solution, e.g. soil samples, food samples, plant samples, tissue samples or aqueous samples of dissolved airborne compounds, or liquid foodstuff e.g. juice, milk, wine and coffee. The sample volume is small and is between about 20 μl, more often 100 μl, and about 20 ml, preferably between 0.3 and 5 ml. Volumes outside the above-defined range may also be applicable, however in rare cases.

The analytes of interest in the sample are preferably compatible with the final analysis equipment and may for example be chosen from any group of volatile or semi-volatile or non-volatile organic or inorganic or organometallic compounds.

The receiving fluid may be a hydrophobic liquid, such as an organic liquid, or an aqueous liquid or a gas. The receiving fluid is preferably chromatography compatible and may for example be a hydrophobic organic liquid or a hydrophilic liquid, such as a buffer. Thus, all analytes in the liquid samples, which are soluble in both types of liquids, can be analysed by using the separation system according to the present invention, particularly small molecules (<1 kDa) which are or which can be uncharged. The receiving fluid can also be a gas.

The membrane support may be hydrophobic or hydrophilic, normally hydrophobic. Examples of membrane supports are polytetrafluoroethylene (PTFE), polyvinylidenedifluoride (PVDF), polypropylene (PP), polyethylene (PE), polystyrene (PS), polysulfone, cellulose, polyethersulfone (PES) and silicone rubber. The membrane support may be provided with a stabilizing backing. The sample fluid containing the analytes is separated from the receiving fluid by the membrane support, serving as a phase separator, thereby facilitating the interaction, i.e. the analyte transfer, between the two fluids in question (interfacial support).

Additionally, the separation unit of the invention may be used in dialysis, wherein molecules diffuse from a first aqueous solution, e.g. blood or urine, through a hydrophilic or hydrophobic membrane, normally a hydrophilic membrane, to a second aqueous solution.

A suitable membrane support for many applications is a Celgard® 2400 or 2500, which is a polypropylene polymer with elongated pores manufactured by Celanese/Hoechst. The membrane support is usually provided in the form of strips or sheets, which are cut into an appropriate form prior or subsequent to assembling of the separation unit. The receiving fluid, preferably a hydrophobic liquid, fills the pores of the polymer as well as the receiving fluid cavity. Alternatively, the sample fluid fills the pores. In yet alternative embodiments, the pores may be filled with a hydrophobic fluid separating two aqueous fluids, or the pores may be filled with an aqueous liquid separating two hydrophobic fluids. The receiving fluid or the sample fluid in the pores constitutes the membrane. Membrane support material made of PTFE are also suitable, e.g. Fluoropore FG from Millipore and TE 35 from Schleicher & Schuell.

The following membrane supports are, among others, applicable to the separation unit according to the invention:

Flat sheets, Hydrophobic:

Accurel® PP, polypropylene, Akzo Nobel

Celgard® 2400, polypropylene, Celanese Corporation

Celgard® 2500, polypropylene, Celanese Corporation

TE 35, PTFE with polyester backing, Schleicher & Schuell, Germany

Fluoropore FGLP, PTFE with polyethene backing, Millipore Corporation, USA

Fluoropore FHUP, PTFE, Millipore Corporation

Durapore GVHP, PVDF, Millipore Corporation

SM11807, PTFE, Sartorius, Germany

Spectrapor, PTFE with polypropylene backing, Spectrum Medical, USA

Flat sheets, Hydrophilic:

Micro PES, sulfonated polyethersulfone, Akzo Nobel

Polyamid PA 6, polyamid

Any other porous hydrophobic or hydrophilic, porous polymer or any micro-porous metallic film may be applied.

The porosity of the membrane support may vary between 0 and 90%, preferably between 40 and 85%. The average pore size is 0-10 μm, preferably about 0.01-0.5 μm. The thickness of the membrane support may vary between 10 and 500 μm, preferably between 10 and 200 μm.

In operation, the sample, preferably an aqueous liquid passes the membrane. Hydrophobic, uncharged molecules then distribute between the sample and the membrane, most often with a much higher affinity for the membrane. The analytes diffuse into the receiving fluid in the receiving fluid cavity. The receiving fluid is preferably kept stagnant during extraction. Hence, extraction over time will lead to an increase in analyte concentration in the receiving fluid compared to the original sample.

The body portion comprises a first and a second wall member and means for fixing the wall members in relation to each other. The wall members are preferably made from a plastic material, such as a polypropylene. The wall members may be coated in case the separation unit is to be used with an aggressive solvent. Thus, they may for example be chromium, gold or platinum plated or they may be coated with a fluorinated polymer such as PTFE. The two wall members may be assembled by fitting of complementary parts provided on the two wall members, such as projections and fitting holes or bores.

The body portion is flattened and defines an upper and a lower surface and at least one rim or edge portion. In this case, the ratio between a maximal height of the rim or edge portion and a maximal diagonal dimension of the upper and lower surface is at most 1 to 4, such as at most 1 to 5, 1 to 6, 1 to 8, 1 to 10, 1 to 12, 1 to 15, 1 to 18, 1 to 20, 1 to 25, 1 to 40, 1 to 60, or 1 to 80.

Grooves or cut-outs may be provided in one or both of the wall members so as to provide the sample fluid and/or the receiving fluid cavities. Thus, the sample fluid cavity may be limited by a groove or cut-out formed in the first wall member and, when a membrane is used as a separation medium, a first surface of the membrane support. Likewise, the receiving fluid cavity may be limited by a groove or cut-out formed in the second wall member and, when a membrane is used as a separation medium, a second surface of the membrane support.

In a preferred embodiment of the separation unit, the first and second wall members are identical which facilitates mass production of the separation unit. Preferably, each wall member is provided with holes and bores arranged with a distance to a number of projections, which preferably equals the number of bores or holes. Thus, the projections of one wall member will fit into the bores or holes of the other wall member when pressing the two members against one another. The first and the second wall members may further comprise means for indicating a correct mutual position of the wall members in relation to each other. Such indications may, e.g., comprise an optical indication such as notch in the wall material or a coloured dot. Alternatively, a protrusion may be provided on one of the surfaces of one of the wall members, whereby the protrusion prevents wrong assembling of the two wall members.

As discussed below in connection with the device for mounting the separation unit in an analyte separating apparatus, the notch for indicating a correct mutual positioning of the two wall members may also be used for fixing the separation unit in relation to the device.

Preferably, the membrane support comprises a sheet or strip, which is arranged between the first and the second wall member.

The separation unit may be a disposable separation unit for one-time use only, or it may be re-used several times.

The separation unit can be moulded by e.g. injection moulding which makes it possible to produce identical first and second wall members. Moulding the two parts of the separation unit in the same mould assures high part-to-part precision in cavity geometry and dimension as well as perfect matching of opposing cavities (cf. FIG. 2c).

One or more of the sample fluid inlets or outlets may comprise a pipe in the body portion, see for example FIG. 14. All inlets and outlets may comprise a pipe. The inlets or outlets may extend at a substantially right angle or at an acute angle to one of the upper and lower surfaces of the body portion. Alternatively, at least one of the inlets and outlets may extend substantially parallel to one of the upper and lower surfaces of the body portion. When the inlets or outlets extend at a right or at an acute angle to one of the upper and lower surfaces, turbulence may be generated in the respective cavities. Turbulence may also be generated when the inlet and/or outlets, in particular the sample fluid inlet, is bent so that the sample fluid takes a sharp turn before entering the sample fluid cavity. A turbulent flow may be desirable in the sample fluid cavity in order to increase diffusion of analytes from the sample fluid to the receiving fluid. The pipe or pipes are preferably integral with the body portion of the separation unit.

Preferably, the inner diameter of the inlets and outlets are substantially equal to a diameter or a maximal width of the grooves or cut-outs. However, the inlets and outlets may also have an inner diameter which is smaller or larger than a diameter or maximal width of the grooves or cut-outs, which might increase mass transfer within the sample fluid or decrease dispersion of receiving fluid.

In order to increase vortex generation and turbulence in the sample fluid cavity, at least the sample fluid cavity may comprise means, such as spoilers, for obstructing the flow of sample fluid through the cavity.

The grooves or cut-outs forming the receiving fluid and sample fluid cavities preferably extend longitudinally in the wall members. The inlets and outlets are preferably arranged at opposing ends of the two grooves.

In order to hold the membrane support in a fixed position between the two wall members, a surface of at least one of the wall members may have a projecting portion. In that case the grooves or cut-outs are preferably formed in the projecting portion. The grooves or cut-outs may be formed in the projection portion solely, or they may also extend into the material of the wall member material. The projection is preferably made from the same material as the wall members. It may be made from a flexible material in order to facilitate assembling of the two wall members.

In certain embodiments of the separation unit, the two wall members may be releasably secured in relation to each other solely by means of friction between portions of the respective wall members which facilitates assembly and disassembly of the separation unit so as to thereby facilitate mounting or exchange of the membrane support.

In further independent aspects, the invention further relates to the use of the separation unit for molecular diffusion, such as in dialysis, and to the use of the separation unit for molecular extraction.

In a second aspect, the present invention relates to a method for fluid-fluid extraction of an analyte from a sample fluid into a receiving fluid in a separation unit as defined in claim 13.

Due to the small volumes of receiving fluid in the receiving fluid cavity, the receiving fluid may be led directly from the receiving fluid outlet to an analysing apparatus, such as a chromatograph. Thus the distance between the receiving fluid outlet and the analysing apparatus may be minimised whereby undesirable dispersion is minimised.

By allowing the separation unit to be discarded and replaced with a new separation unit, frees an operator of the separation unit from disassembling the unit, replacing the membrane support and assembling the unit again. Further, the separation unit may be delivered to the user or operator in a ready-to-use form, whereby the user only needs to unpack the unit and mount it in an appropriate set-up.

It should be understood that any feature and functionality described above in connection with the first aspect of the invention may also be incorporated in or be applicable to the method of the second aspect of the invention and vice versa.

In a third aspect the present invention relates to a device for mounting a separation unit in a separation apparatus as defined in any of claims 8-10.

Preferably, means are provided for pressing against two sides of the separation unit, so as to closely seal the separation medium and the cavities of the separation unit. Thus, the mounting device may have an upper and a lower part between which parts the separation unit may be placed, the two parts being movable towards each other so as to create a pressure on the separation unit. Both the upper and lower part may be movable, or alternatively only one of them may be movable. The upper and lower parts may comprise injectors and extractors for receiving fluid and sample fluid, whereby one single relative movement between the upper and lower part of the device not only confers an appropriate pressure on the separation unit but also properly connects injectors and extractors to the inlets and outlets of the separation unit.

The device may comprise or be operatively connected to a control system for controlling positioning of at least the receiving fluid extractor in relation to the receiving fluid outlet and/or of the sample fluid injector in relation to the sample fluid inlet. The control system may further be adapted to control positioning of the receiving fluid injector in relation to the receiving fluid inlet and/or of the sample fluid extractor in relation to the sample fluid outlet.

In a further aspect the invention relates to a separation system as defined in claim 11.

In a further additional aspect the invention relates to a separation apparatus as defined in claim 12.

The separation unit is either automatically replaceable (utilising a cassette or equivalent means for replacing the used unit with a new unit) or in case many cavities are present in the separation unit the used cavities are automatically replaced by new cavities, see for example FIGS. 2a and 2b.

The separation system according to the invention works in the following manner

The mounting device opens up

The new separation unit is introduced automatically or new cavities in the separation unit are automatically put into position

The mounting device closes—rendering the system ready for operation.

When the separation unit utilises a membrane as a separation medium, the receiving fluid cavity is provided with the receiving fluid volume desired, whereby the receiving fluid extractor will be filled with the receiving fluid. During the sample flow through the separation unit, analytes of interest partition between the sample and the membrane, diffuse into the receiving fluid cavity and are accumulated therein. When the flow of sample fluid through the separation unit has been stopped, i.e. when the extraction operation is over, i.e. after 1-120 min, more often after 5-60 min, mostly after 10-30 min, the receiving fluid containing the analytes is displaced via a fluid delivery system into the analysis apparatus by introducing additional receiving fluid into the receiving fluid cavity. When the analytes in the receiving fluid cavity and the receiving fluid extractor have been displaced, the separation unit and the receiving fluid extractor contain pure receiving fluid, i.e. they have been regenerated and are ready for a new sample flow. Optionally, an intermediate washing step is included.

Alternatively, when the separation unit utilises e.g. chromatographic material as a separation medium the sample fluid and the receiving fluid might be introduced sequentially. The separation medium can in these cases be confined in the sample fluid cavity or in the receiving fluid cavity or in both cavities.

The whole analysis operation or parts thereof including the steps of feeding the separation unit with receiving fluid and sample, the sample flow interruption, the regeneration of the stagnant phase with fresh receiving fluid, the separation, the detection and the data accumulation can be performed automatically, e.g. controlled by a computer system.

The total analysis time is 5-120 min, mostly 10-40 min.

### BRIEF DESCRIPTION OF THE DRAWINGS

FIG. 1a) illustrates a device for mounting a separation unit according to the invention in a separation apparatus,

FIG. 1b) is a front view of the device of FIG. 1a),

FIG. 1c) is a side view of the device of FIGS. 1a) and 1b),

FIG. 2a) illustrates a separation system wherein A is the mounting device, B are hole(s) to access the cavities of the separation unit, C is the separation unit and D is connecting tube,

FIG. 2b) illustrates an example of a separation unit containing multiple cavities.

FIG. 2c) illustrates an example of a cross-section of the two wall members of the body portion wherein F is the first wall member and G the second wall member,

FIG. 3 is an exploded view illustration of a third embodiment of a separation unit according to the invention,

FIG. 4 is an illustration of the separation unit of FIG. 3 when assembled,

FIG. 5 illustrates a wall member of the separation unit of FIGS. 3 and 4,

FIG. 6 is a bottom view of the wall member FIG. 5,

FIG. 7 is a cross-sectional illustration along line A-A of FIG. 6,

FIG. 8 is a cross-sectional illustration along line B-B of FIG. 6,

FIG. 9 is an illustration of detail C of FIG. 8,

FIG. 10 is an illustration of detail F of FIG. 8,

FIG. 11 is an illustration of a wall member for a fourth embodiment of the separation unit according to the invention,

FIG. 12 is a side view of the wall member of FIG. 11,

FIG. 13 is a bottom view of the wall member of FIGS. 11 and 12,

FIG. 14 is a cross-sectional view along line A-A of FIG. 13,

FIG. 15 illustrates a detail of a separation unit according to the invention mounted in a mounting device according to the invention,

### DETAILED DESCRIPTION OF THE DRAWINGS

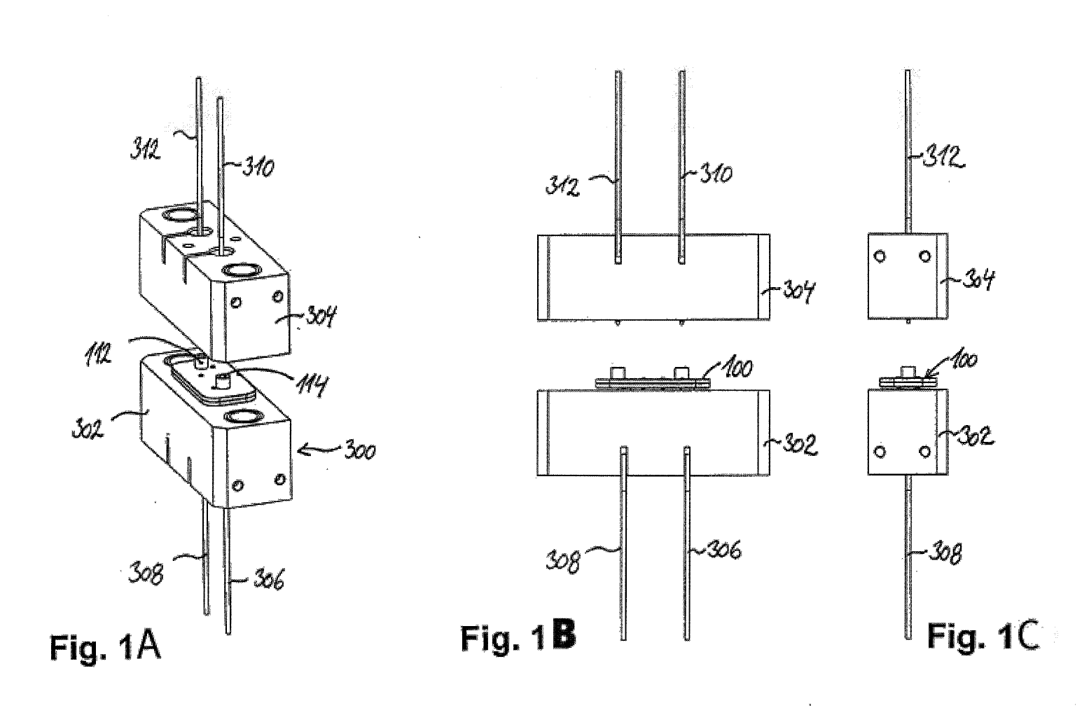

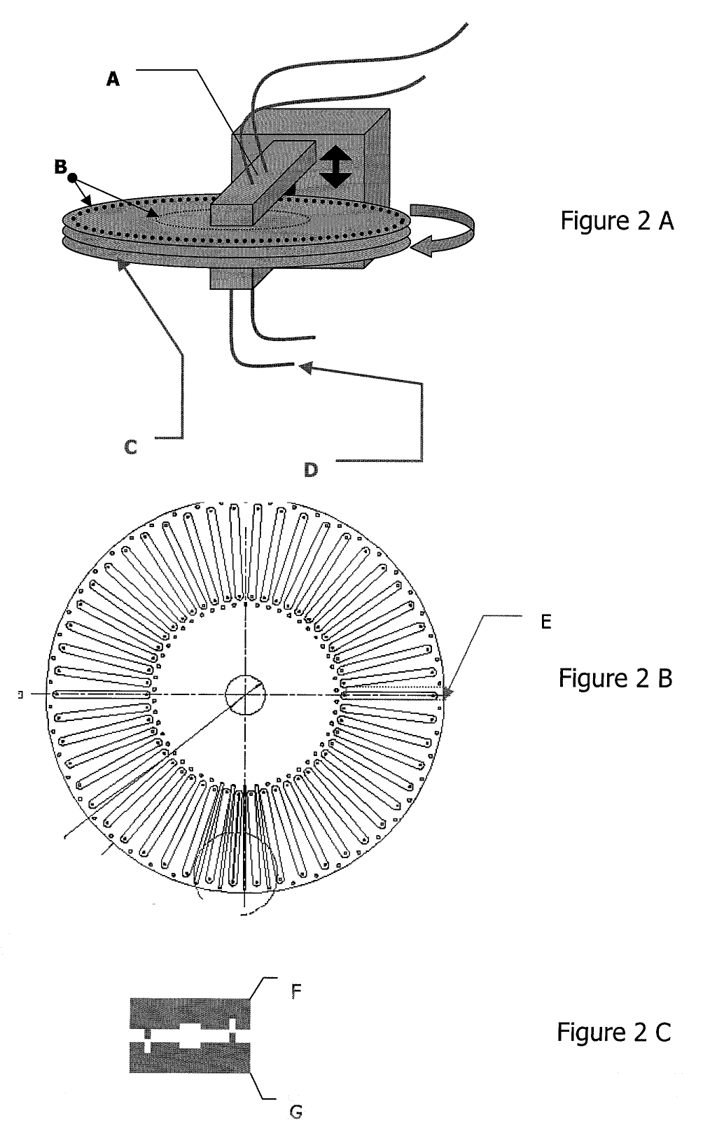

FIGS. 1a), 1b) and 1c) illustrate a device 300 for mounting a separation unit 100 in a separation apparatus. The device comprises a lower part 302 through which receiving fluid is led to and from the separation unit via a receiving fluid injector 306 and a receiving fluid extractor 308, and an upper part 304 through which sample fluid is led to and from the separation unit via a sample fluid injector 310 and a sample fluid extractor 312. The receiving fluid extractor 308 may be directly connected to an analysis device.

In FIGS. 1a), 1b) and 1c) the separation unit 100 is inserted into the device 300 in a way that prevents wrong positioning of the separation unit in relation to the device. After insertion of the separation unit 100, the lower part 302 of the device and the upper part 304 are clamped together, thus creating a pressure that seals the grooves of the separation unit against the membrane support. Either one of the upper and lower parts 302 and 304 may be movable, or they may both be movable. They can be manually moved by mechanical means, which may be electrically, pneumatically or hydraulically supported.

The separation unit can be inserted from the long end (FIG. 1b) or from the short end (FIG. 1c).

There may be provided an indication, such as a light diode, that is lit when the separation unit is correctly positioned, thus either triggering the upper and lower parts 302 and 304 to clamp the separation unit or telling the operator that he or she may close the device.

FIG. 2a) illustrates a separation system according to the invention wherein the separation unit has a circular shape with multiple cavities. FIG. 2b) illustrates the inside of the separation unit, which is used in the separation system in FIG. 2a),

FIG. 2c) illustrates a cross-sectional view of the body portion with the two wall members of a separation unit provided with guiding protrusions for accurate positioning of the two parts.

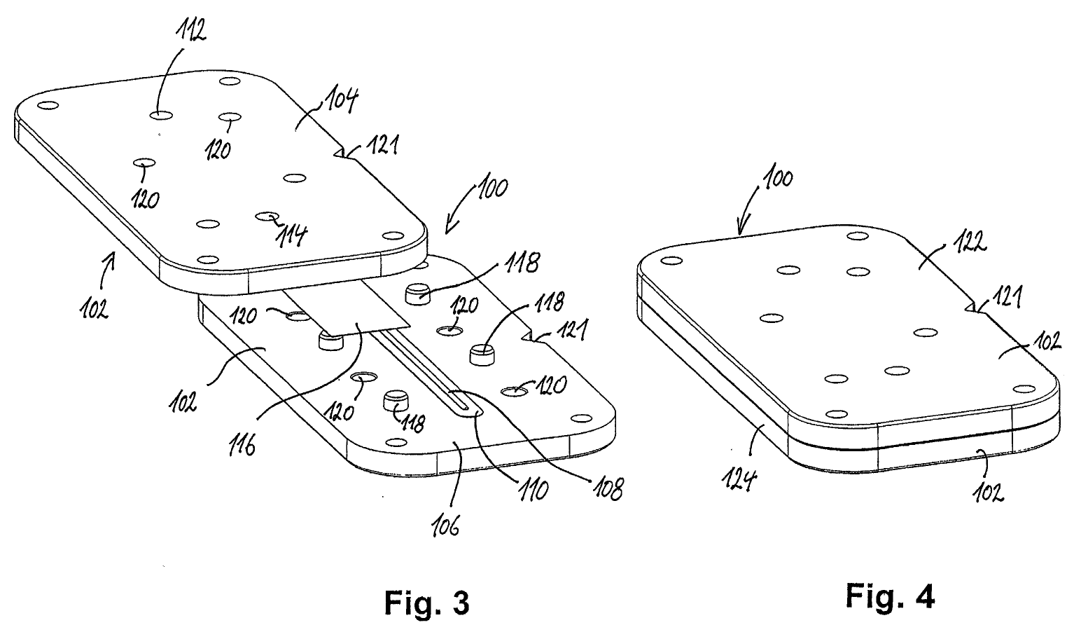

FIG. 3 is an exploded view illustration of a separation unit 100. The unit comprises two identical wall members 102, each of which has an upper surface 104 and a lower surface 106. The two wall members 102 and means for fixing the wall members in relation to each other together define a body portion of the separation unit. On each wall member, a groove 108 is provided in a protrusion 110. The groove 108 of one of the wall members constitutes a sample fluid cavity, whereas the groove 108 of the other one of the wall members constitutes a receiving fluid cavity. Inlets 112 and outlets 114 are provided in one of the wall members for inlet and outlet of sample fluid, whereas identical inlets and outlets are provided in the other one of the wall members for receiving fluid inlet and receiving fluid outlet. A membrane support 116 is provided between the two wall members. Projections 118 are provided on each one of the wall members. The projections 118 fit into corresponding holes 120, which are further, provided in each one of the wall members. Notches 121 are provided in each one of the wall members so as to indicate to the person assembling the wall members that they are positioned correctly in relation to each other when he or she assembles the separation unit. FIG. 4 illustrates the assembled separation unit having an upper and a lower surface 122 and an edge portion 124.

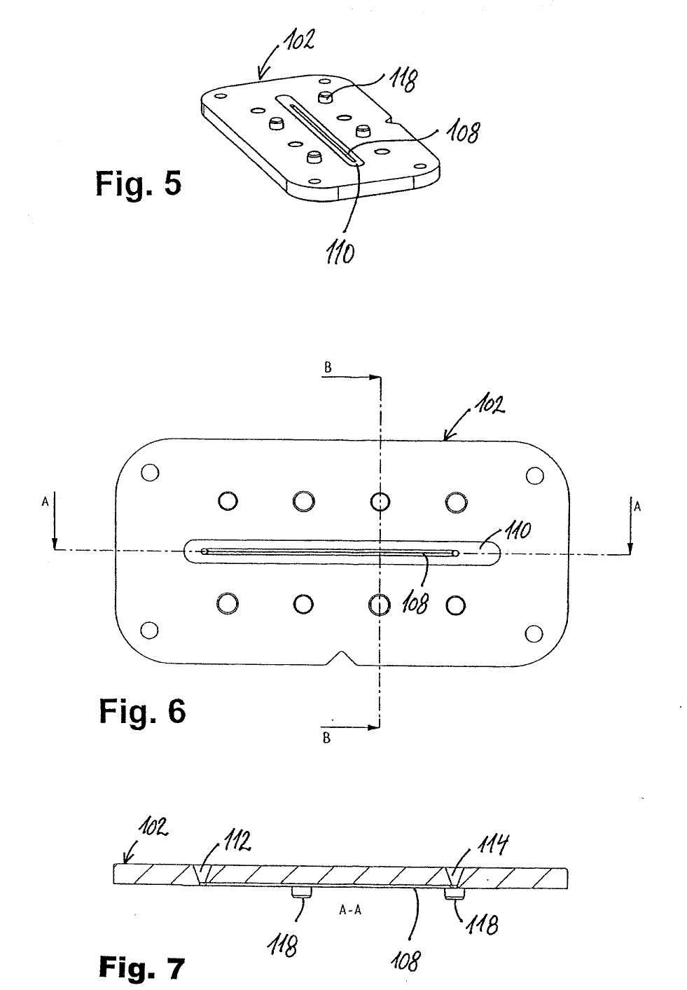

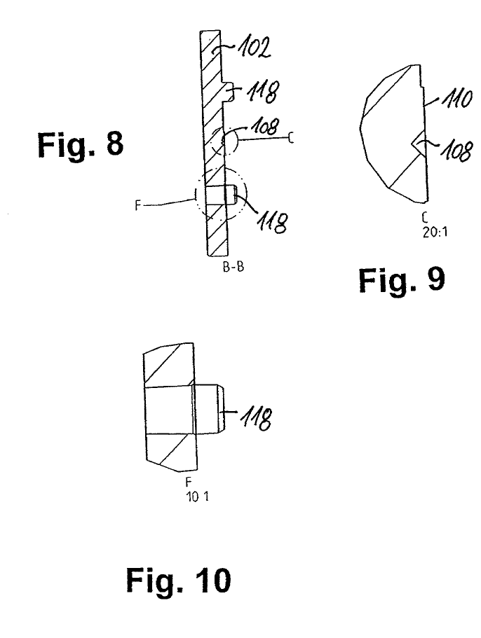

FIGS. 5-10 illustrate a wall member 102 of the separation unit of FIGS. 3 and 4. In FIG. 7, which is a cross-sectional illustration along line A-A in FIG. 6, the inlet 112 and outlet 114 are funnel-shaped so as to be complementary with a conical end of a conical end portion of an injector and extractor for sample fluid and receiving fluid, respectively. FIG. 8 is a cross-sectional illustration along line B-B of FIG. 6. As illustrated in the detail of FIG. 9, the groove 108 has a triangular shape. Any other geometry of the groove is possible such as rectangular, rounded, etc.

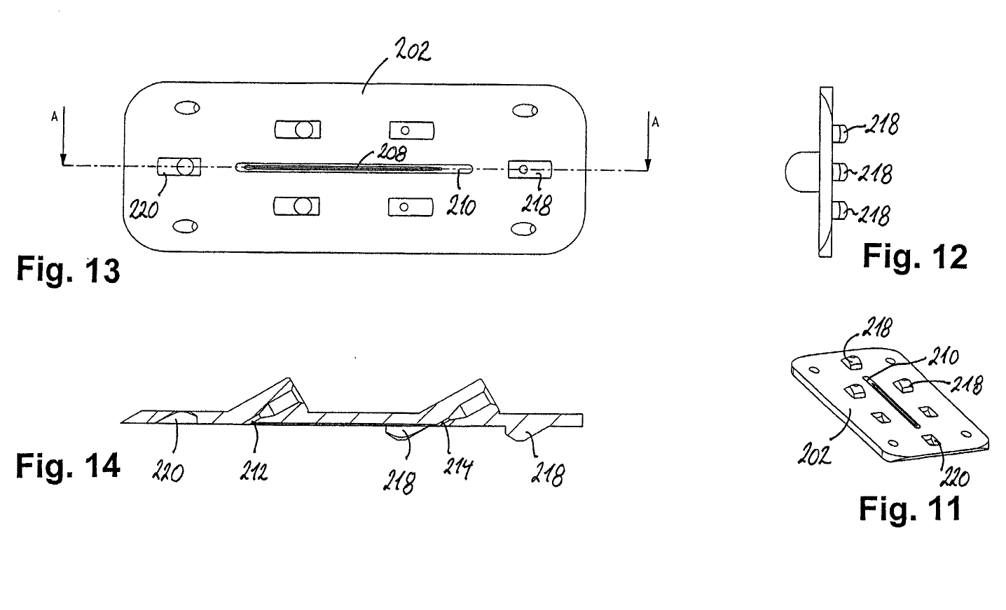

FIGS. 11-14 illustrate a wall member 202 for a second embodiment of the separation unit according to the invention. The wall member comprises a groove 208 constituting a cavity for either the sample fluid or the receiving fluid. The groove is provided in a protrusion 210. The cross-sectional view of FIG. 14 illustrates that an inlet 212 and an outlet 214 are arranged at acute angles to an upper surface 204 of the wall member. The inlet and outlet are partly funnel-shaped. Projections 218 and holes 220 are provided for fitting two identical wall parts together, so as to form a separation unit, wherein the inlets and outlets for sample fluid and receiving fluid are arranged at an acute angle to the upper and lower surface of the separation unit.

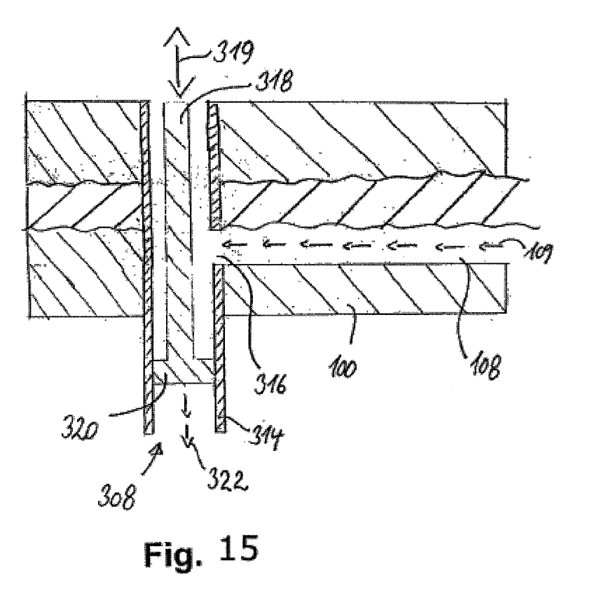

FIG. 15 illustrates a detail of a separation unit 100 according to the invention mounted in the device of FIGS. 15-17, more particularly the fitting of the receiving fluid extractor 308 into the receiving fluid outlet of the separation unit. The receiving fluid extractor 308 comprises a tube 314 provided with an opening 316 in a wall of the tube, the opening 316 being aligned with the groove 108 of the separation unit. In the tube 314, a piston 318 is provided which is moveable in an upward and a downward direction as indicated by arrow 319. The piston comprises a plunger 320. When analytes are diffusing into the receiving fluid in the groove 108, the piston 318 is either in a position in which the plunger 320 is above the opening 316 or in a position in which the plunger 320 blocks the opening 316. When diffusion of analytes has completed, the receiving fluid 109 is dislocated from the groove 108, through opening 316, into the tube 314. The plunger 320 is thereafter moved downwards, pressing receiving fluid into e.g. a chromatograph, as indicated by arrows 322. Before a fresh amount of receiving fluid is led into the groove 108, the plunger 320 may be moved back to its initial position in which it blocks the opening 316 in the tube wall. Moving receiving fluid in the groove 108 will now regenerate new receiving fluid in the membrane support. Thereafter the plunger is moved to a position above the opening 316, and the groove 108 is filled with receiving fluid. The plunger 320 may also be moved to a position above the opening 316 prior to leading receiving fluid into the groove 108 in order to regenerate the membrane support. The piston and the plunger may be spring biased towards the position in which the plunger block the opening in the tube wall. The piston and the plunger may also be movable by means of e.g. hydraulic, electric or pneumatic driving means.

Preferably, the tube 314 is formed as a tube made from stainless steel with the opening 316 being formed as a bore or drilled hole. Preferably, the plunger 320 is moved so fast when displacing receiving fluid into an analysis apparatus that a so-called split-splitless injector on a gas chromatograph may be used optimally. The tube 314 may have a conical outer shape, which facilitates insertion of the tube into the receiving fluid outlet of the separation unit.

The other injectors and extractors of the device of FIGS. 1a), 1b) and 1c) may be designed in a similar way.

What is claimed is:

1. A separation unit to be put into position by insertion in a mounting device for use in separation of an analyte from a sample fluid to a receiving fluid, the unit comprising:
a two part body portion with at least one sample fluid cavity for accommodating sample fluid, and at least one receiving fluid cavity for accommodating receiving fluid, whereby each sample fluid cavity is connected to its corresponding receiving fluid cavity,
each sample fluid cavity comprises a sample fluid inlet for leading sample fluid into the sample fluid cavity, and a sample fluid outlet for leading sample fluid out of the sample fluid cavity,
each receiving fluid cavity comprises a receiving fluid inlet for leading receiving fluid into the receiving fluid cavity, and a receiving fluid outlet for leading receiving fluid out of the receiving fluid cavity.

2. A separation unit according to claim 1 which includes at least one separation medium.

3. A separation unit according to claim 1, wherein the body portion defines upper and lower surfaces and at least one rim or edge portion, and wherein the ratio between a maximal height of the rim or edge portion and a maximal diagonal dimension of the upper and lower surface is at most 1 to 4.

4. A separation unit according to claim 2, wherein the separation medium is a membrane support comprising a sheet or strip arranged between a first and a second wall member.

5. A separation unit according to any of claim 1, wherein the first and second wall members are identical.

6. A separation unit according to any of claim 1, which contains more than one sample fluid cavity and more than one receiving fluid cavity.

7. A separation unit according to any of claim 1, wherein a surface of at least one of the wall members has a projecting portion, and wherein at least one of the grooves or cut-outs is formed in the projecting portion, whereby the projecting portion contributes to fix the membrane support in an operating position between the wall members.

8. A device for mounting a separation unit in a separation apparatus, the device comprising:
a receiving fluid injector connectable to the receiving fluid inlet,
a receiving fluid extractor connectable to the receiving fluid outlet,
a sample fluid injector connectable to the receiving fluid inlet,
a sample fluid extractor connectable to the receiving fluid outlet.

9. A device according to claim 8, wherein the device comprises a control system for controlling positioning of at least the receiving fluid extractor in relation to the receiving fluid outlet.

10. A device according to claim 8, wherein the device comprises a control system for controlling positioning of at least the sample fluid injector in relation to the sample fluid inlet.

11. A separation system for fluid-fluid extraction comprising a separation unit according to claim 1.

12. A separation apparatus for fluid-fluid extraction comprising means for introducing sample fluid to a mounting device according to claim 8.

13. A method for fluid-fluid extraction of an analyte from a sample fluid to a receiving fluid in a separation apparatus according to claim 12, comprising the steps of:
leading a receiving fluid through the receiving fluid inlet into the receiving fluid cavity,
continuously leading a sample fluid through the sample fluid inlet into the sample fluid cavity and out of the sample fluid outlet,
leading the receiving fluid out of the receiving fluid cavity through the receiving fluid outlet.

14. A method according to claim 13, wherein the sample fluid and the receiving fluid contact the separation medium simultaneously.

15. A method according to claim 13, wherein the sample fluid and the receiving fluid contact the separation medium sequentially.

16. A method according to any of claim 13, wherein, subsequent to leading an amount of sample fluid out of the sample fluid cavity, an amount of sample fluid is led back into the sample fluid cavity through the sample fluid inlet or back through the sample fluid outlet.

17. A method according to any of claim 13, wherein the receiving fluid outlet is connected directly to an apparatus for analysing an analyte in the receiving fluid.

18. A method according to any of claim 13, wherein the steps of the method are repeated with one separation unit.

19. A method according to any of claim 13, wherein the separation unit is replaced with a new separation unit after one separation.

20. The use of a separation system according to claim 11 for molecular diffusion.

21. The use of claim 20, wherein the diffusion comprises dialysis.

22. The use of a separation system according to claim 11 for molecular extraction.
